(19) United States
(12) Patent Application Publication
(10) Pub. No.: US 2025/0313107 A1
(43) Pub. Date: Oct. 9, 2025

(54) ATTACHMENT/DETACHMENT DEVICE AND A CHARGING MODULE INCLUDING THE SAME

(71) Applicants: HYUNDAI MOTOR COMPANY, Seoul (KR); KIA CORPORATION, Seoul (KR)

(72) Inventors: Yong Chul Shin, Hwaseong-si (KR); Ki Hoon Nam, Hwaseong-si (KR); Ji Su Kim, Hwaseong-si (KR); Byung Ho Yoon, Hwaseong-si (KR); Hwa Woong Yoo, Hwaseong-si (KR)

(73) Assignees: HYUNDAI MOTOR COMPANY, Seoul (KR); KIA CORPORATION, Seoul (KR)

(21) Appl. No.: 18/920,445

(22) Filed: Oct. 18, 2024

(30) Foreign Application Priority Data
Apr. 9, 2024 (KR) 10-2024-0048158

(51) Int. Cl. B60L 53/35; B60L 53/16; H02J 7/00

(52) U.S. Cl. CPC B60L 53/35; B60L 53/16; H02J 7/0042

(57) ABSTRACT

An attachment/detachment device including: a driving part configured to rotate about a driving axis; a pressing part configured to rotate in conjunction with the rotation of the driving axis; a movable part configured to be movable by the rotation of the pressing part; an elastic member configured to press the movable part; a coupling member provided to face the movable part; and one or more ball members accommodated in the coupling member. The one or more ball members are provided to protrude outward from the coupling member.

### CROSS-REFERENCE TO RELATED APPLICATION

This application claims priority to and the benefit of Korean Patent Application No. 10-2024-0048158 filed in the Korean Intellectual Property Office on Apr. 9, 2024, the entire contents of which are incorporated herein by reference.

### TECHNICAL FIELD

The present disclosure relates to an attachment/detachment device and a charging module including the same. More particularly, the present disclosure relates to an attachment/detachment device, to or from which a charger may be attached or detached, and a charging module including the attachment/detachment device and charger.

### BACKGROUND

In order to expand the adoption of electric vehicles, it is necessary not only to expand the distribution of electric vehicles, but also to expand the infrastructure required to use the electric vehicles. For example, because electric vehicles need to be periodically charged, it is necessary to expand the charging infrastructure capable of charging the electric vehicles.

An electric vehicle charging facility required for a charging infrastructure related to electric vehicles includes an electric vehicle charger, and a tool changer configured to be coupled to the electric vehicle charger. In order to charge the electric vehicle, i) the tool changer may move toward the electric vehicle when the charger is coupled to the tool changer, ii) the tool changer may couple the charger to the electric vehicle, and iii) the tool changer may move away from the charger. In addition, when the electric vehicle is completely charged, i) the tool changer may move toward the charger and engage with the charger, ii) the tool changer may separate the charger from the electric vehicle and couple the charger to a cradle for a charger, and iv) the tool changer may move away from the charger.

However, the tool changer for a charger in the related art uses pneumatic pressure, making it unsuitable to be used for an outdoor electric vehicle charging station. Furthermore, in the related art, because an operator manually performs the process of coupling the charger to the tool changer and uncoupling the tool changer and the charger, there is a problem in that it is difficult to implement the complete automation of the electric vehicle charging facility.

### SUMMARY

The present disclosure provides a device capable of having a reduced size and automating a process of supplying a charger to an electric power demander, such as an electric vehicle, without the manipulation of an operator.

In order to achieve the above-mentioned object, one aspect of the present disclosure provides an attachment/detachment device including: a driving part having a driving axis and configured to rotate about the driving axis; a pressing part configured to rotate in conjunction with the rotation of the driving axis; a movable part provided at one side of the pressing part and configured to be movable in a first direction D1 by the rotation of the pressing part; and an elastic member provided at one side of the movable part and configured to press the movable part in a second direction D2 that is different from the first direction D1. The attachment/detachment device further include: a coupling member provided to face one side of the movable part based on the second direction D2; and one or more ball members accommodated in the coupling member. The one or more ball members are provided to protrude outward from the coupling member. The one or more ball members are positioned at a predetermined position in relation to the coupling member in a first state in which the movable part is moved in the first direction D1 as the pressing part presses the movable part by an operation of the driving part. The movable part presses the one or more ball members in an inward direction, which is a direction opposite to an outward direction R, and the one or more ball members move toward an inside of the coupling member from a position of the one or more ball members in the first state to a position of the one or more ball members in a second state in which the movable part is moved in the second direction D2 by a predetermined distance in comparison with the first state.

The pressing part may be configured to revolve around the driving axis A1 of the driving part.

The movable part may include: a slider member having an internal space for accommodating the elastic member; and a cup member provided at one side of the slider member based on the second direction D2 and fixedly coupled to the slider member.

The attachment/detachment device may further include: a support member having one side at which the slider member and the elastic member are provided. An end of the elastic member based on the first direction D1 is in contact with an inner surface of the support member. An end of the elastic member based on the second direction D2 is in contact with an inner surface of the slider member provided at one side based on the second direction D2 and configured to define the internal space of the slider member.

The coupling member may include a coupling region in which a plurality of accommodation holes for accommodating the one or more ball members is formed in a circumferential direction in an outer surface of the coupling region based on the outward direction R.

The attachment/detachment device may further include: a fixing member fixed to a lateral portion of the support member based on the second direction D2. The coupling member is fixedly coupled to a lateral portion of the fixing member based on the second direction D2. The cup member is inserted into the fixing member and provided to face the coupling member.

The elastic member may include first and second elastic members spaced apart from each other in a third direction D3 intersecting the first direction D1.

The pressing part may be provided between the first and second elastic members in the third direction D3.

The cup member may have a recessed region having a shape opened in the second direction D2 and having a shape recessed in the first direction D1. An inner surface of the recessed region based on the inward direction may include a first-first inclined section having a width based on an outward direction R that decreases in the first direction D1.

An outer surface of the coupling region based on the outward direction R may include a first-second inclined section having a width based on the outward direction R that decreases in the first direction D1. The first-first inclined section may be provided outward of the first-second inclined section in the outward direction R.

A gradient of the first-first inclined section with respect to the first direction D1 and a gradient of the first-second inclined section with respect to the first direction D1 may correspond to each other.

The one or more ball members may be spaced apart from the first-first inclined section in the first state, and the one or more ball members may be pressed by the first-first inclined section in the second state.

In order to achieve the above-mentioned object, another aspect of the present disclosure provides a charging module including: the attachment/detachment device; and a charger detachably provided on the attachment/detachment device. The charger includes: a bracket member provided to face the coupling member of the attachment/detachment device; and a connection pin member protruding from the bracket member toward the coupling member and configured to be inserted into the coupling member. The one or more ball members press an outer surface based on the outward direction R of the connection pin member inserted into one side of the movable part in the second state.

In the second state, the one or more ball members may be provided between the connection pin member and a region based on the outward direction R of the movable part that presses the one or more ball members.

The movable part may include: a slider member having an internal space for accommodating the elastic member; and a cup member provided at one side of the slider member based on the second direction D2 and fixedly coupled to the slider member. The coupling member may include a coupling region having an outer surface with a cylindrical shape and having a plurality of accommodation holes configured to accommodate the one or more ball members and formed in the outer surface in a circumferential direction of the cylindrical shape.

The cup member may have a recessed region having a shape opened in the second direction D2 and having a shape recessed in the first direction D1. An inner surface of the recessed region may include a first-first inclined section having a width based on the outward direction R that decreases in the first direction D1. An outer surface of the coupling region includes a first-second inclined section having a width based on the outward direction R that decreases in the first direction D1. The first-first inclined section may be provided outward of the first-second inclined section in the outward direction R.

An outer surface of the connection pin member based on the outward direction R may include a second-first inclined section having a width based on the outward direction R that increases in the first direction D1. The second-first inclined section and the one or more ball members may be provided to overlap each other in the first direction D1 when the connection pin member is inserted into the coupling member in the first state.

The outer surface of the connection pin member based on the outward direction R may further include a second-second inclined section connected to an end of the second-first inclined section based on the second direction D2 and having a width based on the outward direction R that decreases in the first direction D1.

In order to achieve the above-mentioned object, still another aspect of the present disclosure provides a charging module including: an attachment/detachment device; and a charger detachably provided on the attachment/detachment device. The attachment/detachment device includes: a driving part including a driving axis and configured to rotate about the driving axis; a pressing part configured to rotate in conjunction with the rotation of the driving axis; and a movable part provided at one side of the pressing part and configured to be movable in a first direction D1 by the rotation of the pressing part. The attachment/detachment device also includes: an elastic member provided at one side of the movable part and configured to press the movable part in a second direction D2 that is a direction opposite to the first direction D1; and a coupling member provided to face one side of the movable part based on the second direction D2. The charger also includes: a bracket member provided to face the coupling member of the attachment/detachment device; and a connection pin member protruding from the bracket member toward the coupling member and configured to be inserted into the coupling member. An end of the movable part based on the second direction D2 and the connection pin member are attachable to or detachable from each other by a magnetic force.

The end of the movable part based on the second direction D2 may include an electromagnet, and the connection pin member may include a permanent magnet.

According to the present disclosure, it is possible to provide the device capable of automating the process of supplying the charger to the electric power demander, such as the electric vehicle, without a manipulation of an operator.

### BRIEF DESCRIPTION OF THE DRAWINGS

The above and other objects, features, and advantages of the present disclosure should be more apparent from the following detailed description taken in conjunction with the accompanying drawings below.

FIG. 1 is a view illustrating a state of a charging module according to an embodiment of the present disclosure when viewed from a first side.

FIG. 2 is a view illustrating a state of the charging module according to an embodiment of the present disclosure when viewed from a second side.

FIG. 3 is a side view of the charging module according to an embodiment of the present disclosure.

FIG. 4 is a view illustrating internal cross-sectional structures of some components of a charger and an attachment/detachment device of a charging module according to an embodiment of the present disclosure.

FIG. 5 is a view illustrating a structure for coupling a driving part and a pressing part in FIG. 4.

FIG. 6 is a cross-sectional view illustrating states of an attachment/detachment device and a charger in a first state of a charging module according to an embodiment of the present disclosure.

FIG. 7 is a view illustrating a positional relationship between a cup member, a plurality of ball members, and a coupling member in FIG. 6.

FIG. 8 is a cross-sectional view illustrating states of an attachment/detachment device and a charger in a second state of a charging module according to an embodiment of the present disclosure.

FIG. 9 is a view illustrating a positional relationship between a cup member, a plurality of ball members, and a coupling member in FIG. 8.

FIG. 10 is a view illustrating internal cross-sectional structures of some components of a charger and an attachment/detachment device of a charging module according to another embodiment of the present disclosure.

### DETAILED DESCRIPTION

Embodiments are hereinafter described in detail with reference to the accompanying drawings.

The embodiments disclosed in the present specification and the constructions depicted in the drawings are only example embodiments of the present disclosure, and do not cover the entire scope of the present disclosure. Therefore, it should be understood that there may be various equivalents and variations at the time of the application of this specification.

In order to clarify the present disclosure, parts that are not related to the description have been omitted. Also, the same elements or equivalents are referred to with the same reference numerals throughout the specification.

Also the size and thickness of each element are arbitrarily shown in the drawings, but the present disclosure is not necessarily limited thereto. Additionally, in the drawings, the thickness of layers, films, panels, regions, and the like, may be exaggerated for clarity.

When a component, device, element, or the like of the present disclosure is described as having a purpose or performing an operation, function, or the like, the component, device, or element should be considered herein as being “configured to” meet that purpose or perform that operation or function.

Hereinafter, a charging module and a method of operating the charging module according to the present disclosure is described with reference to the drawings.

### Charging Module

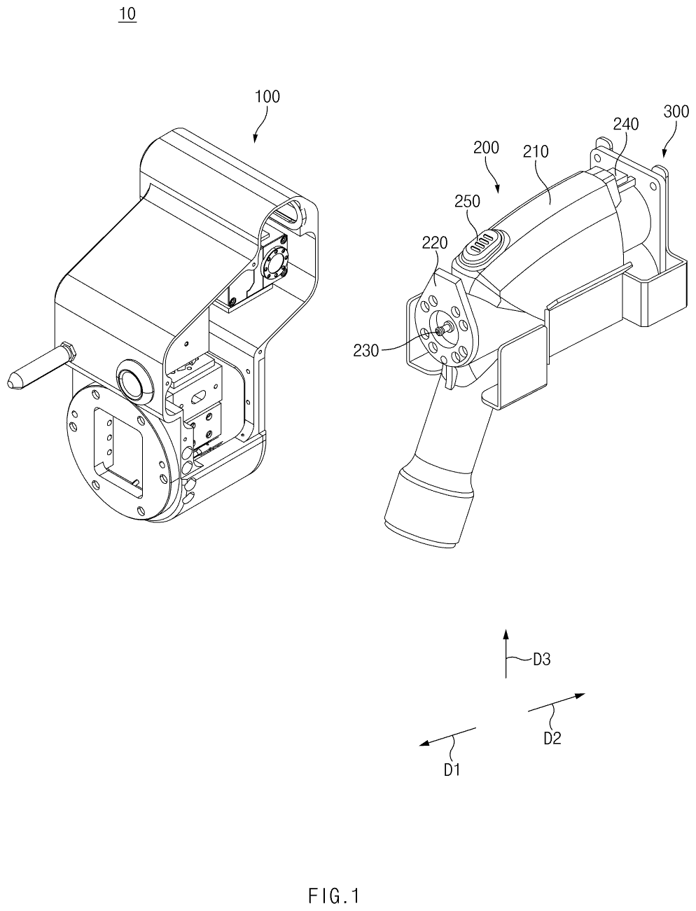

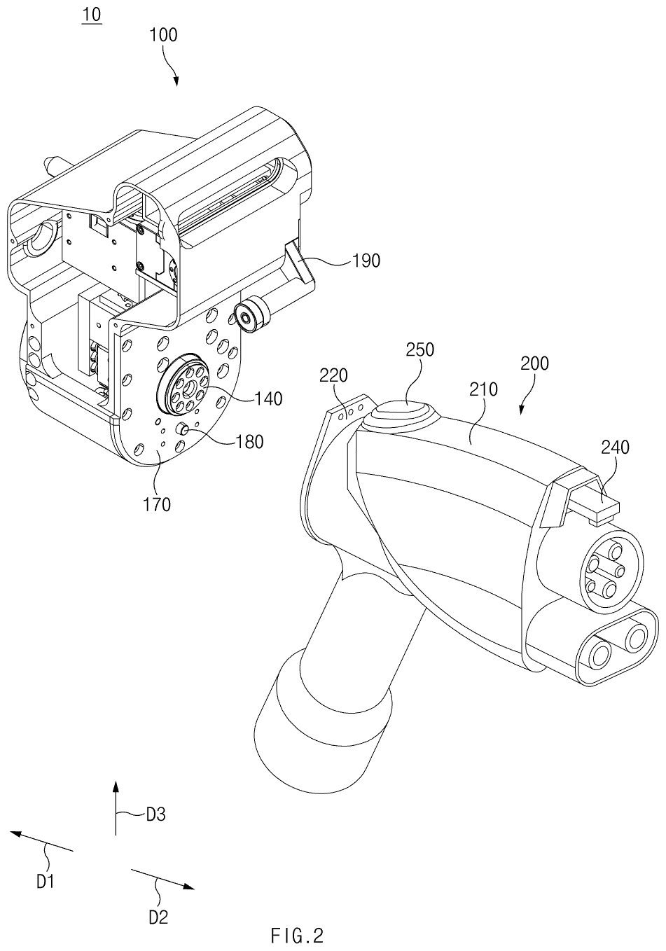

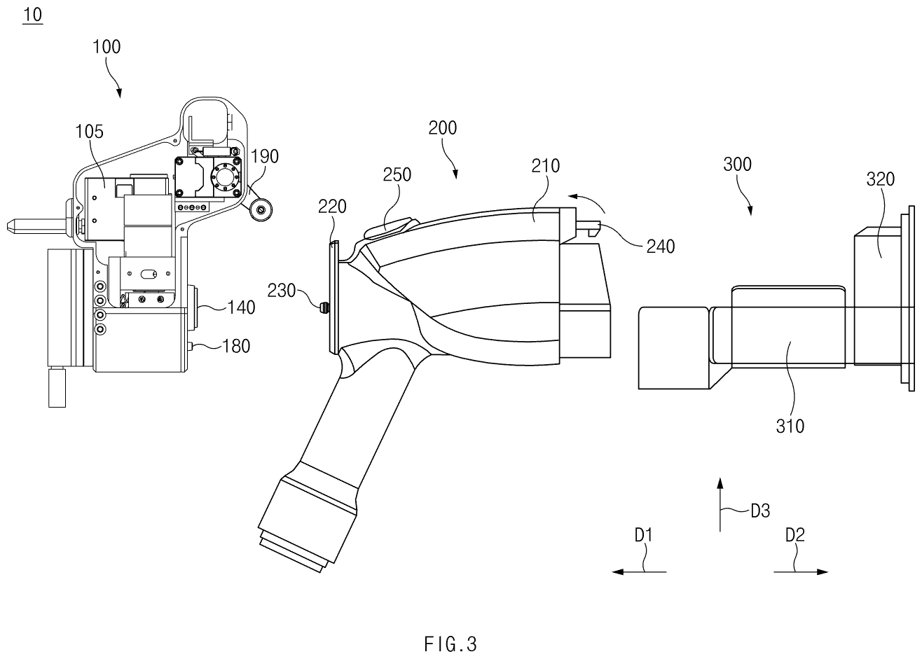

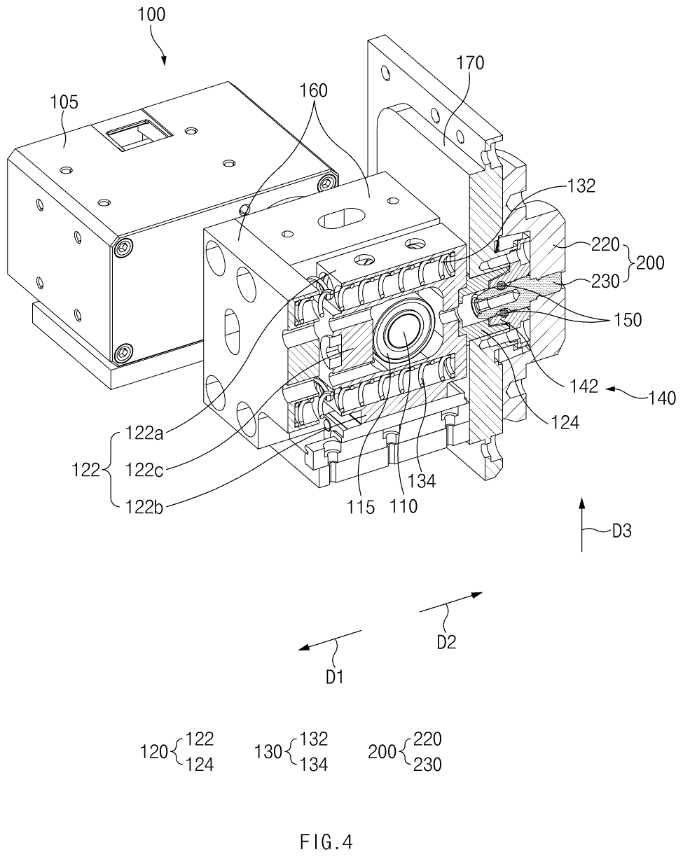

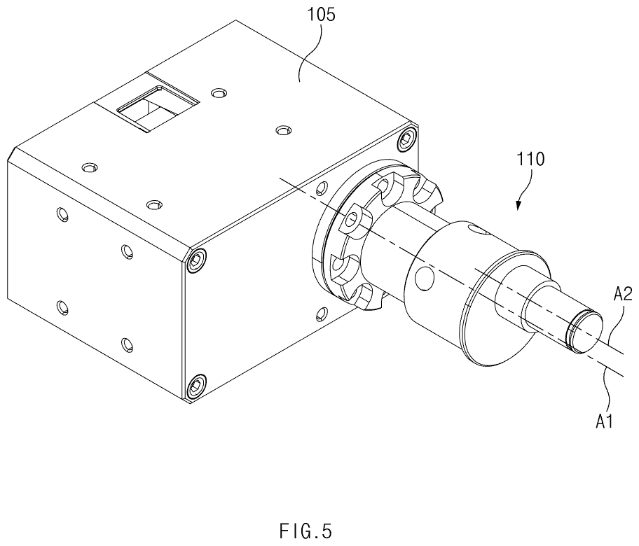

FIG. 1 is a view illustrating a state of a charging module according to an embodiment of the present disclosure when viewed from a first side. FIG. 2 is a view illustrating a state of the charging module according to the embodiment of the present disclosure when viewed from a second side. FIG. 3 is a side view of the charging module according to the embodiment of the present disclosure. FIG. 4 is a view illustrating the internal cross-sectional structures of some components of a charger and an attachment/detachment device of the charging module according to the embodiment of the present disclosure. FIG. 5 is a view illustrating a structure for coupling a driving part and a pressing part in FIG. 4.

With reference to FIGS. 1-5, a charging module 10 according to the present disclosure may include an electric charger 200 (hereinafter, referred to as a ‘charger’), and an attachment/detachment device 100 on which the electric charger 200 is detachably provided. The charging module 10 according to the present disclosure may be configured to automate a process of charging an external electric power demander, such as an electric vehicle, without the manipulation of an operator. More specifically, the attachment/detachment device 100 according to the present disclosure may have a structure to or from which various types of chargers 200 may be attached or detached. Therefore, according to the present disclosure, various types of electric vehicles may be charged by using the single attachment/detachment device 100. However, the charging module 10 according to the present disclosure may be used to charge other devices in addition to the electric vehicle. Furthermore, in the present specification, the electric vehicle may be understood as a concept including movable bodies, such as PBVs, robots, and other mobility vehicles, as well as a general vehicle, that needs to be charged.

With reference to FIGS. 1-5, the attachment/detachment device 100 according to the present disclosure may include a driving part 105 including a driving axis A1, and configured to rotate about the driving axis A1. For example, the driving part 105 may be an electric motor.

The attachment/detachment device 100 may include a pressing part 110 configured to rotate in conjunction with the rotation of the driving axis A1. The pressing part 110 may be configured to revolve around the driving axis A1 of the driving part 105. Therefore, a position of the pressing part 110 relative to the driving part 105 may vary depending on the rotation of the driving axis A1. For example, the pressing part 110 may be connected directly to the driving axis A1. Alternatively, the pressing part 110 may be connected indirectly to the driving axis A1 by another mediated component.

Additionally, according to the present disclosure, a central axis A2 of the pressing part 110 may extend in one direction from the center of gravity of the pressing part 110 and be provided to be parallel to an extension direction of the driving axis A1. The central axis A2 may be spaced apart from the driving axis A1. The driving axis A1 of the driving part 105 and the central axis A2 of the pressing part 110 may be spaced apart from each other without being disposed coaxially. In other words, with reference to FIG. 5, the driving axis A1 of the driving part 105 and the central axis A2 of the pressing part 110 may be spaced apart from each other in a direction perpendicular to the direction in which the driving axis A1 extends. In this case, it may be understood that the pressing part 110 performs an eccentric rotational motion in the state in which the central axis A2 is spaced apart from the driving axis A1.

The attachment/detachment device 100 may further include a movable part 120 provided at one side of the pressing part 110 and configured to be movable in a first direction D1 by the revolution motion of the pressing part 110 around the driving axis A1. More specifically, the pressing part 110 may press and move the movable part 120 in the first direction D1. For example, assuming that a direction in which the attachment/detachment device 100 faces the charger 200 is a forward direction, the first direction D1 may be a rearward direction.

With continued reference to FIGS. 1-5, the attachment/detachment device 100 may further include elastic members 130 provided at one side of the movable part 120 and configured to press the movable part 120 in a second direction D2 different from the first direction D1. In this case, the second direction D2 may include a direction component opposite to the first direction D1. More particularly, the second direction D2 may be a direction opposite to the first direction D1. In other words, according to the present disclosure, the direction in which the pressing part 110 presses the movable part 120 by the rotational motion of the pressing part 110 may be opposite to the direction in which the elastic member 130 presses the movable part 120. However, the elastic member 130 may be configured to press the movable part 120 at ordinary times even though the magnitude varies, whereas the pressing part 110 may be configured to selectively press the movable part 120 depending on the driving state of the driving part 105. As described below, according to the present disclosure, the elastic member 130 may be configured to press the movable part 120 in a direction in which the attachment/detachment device 100 and the charger 200 are coupled, and the pressing part 110 may be configured to press the movable part 120 in a direction in which the attachment/detachment device 100 and the charger 200 may be uncoupled. As described above, when the first direction D1 is a rearward direction, the second direction D2 may be a forward direction.

According to the present disclosure, the attachment/detachment device 100 may further include a coupling member 140 provided to face one side of the movable part 120 based on the second direction D2, and one or more ball members 150 accommodated in the coupling member 140. More particularly, the ball members 150 may be provided as a plurality of ball members 150. In addition, the movable part 120 may be configured to be movable relative to the coupling member 140. More specifically, the coupling member 140 may be fixed to one side of the attachment/detachment device 100 regardless of the motion of the movable part 120. The coupling member 140 may have an approximately rotationally symmetrical shape with respect to an imaginary rotation axis parallel to the first direction D1 or the second direction D2. Hereinafter, in the present specification, a direction directed toward the outside from a center of the coupling member 140, i.e., a direction perpendicularly intersecting the first direction D1 and the second direction D2 is defined as an outward direction R of the attachment/detachment device 100. In case the coupling member 140 has a rotationally symmetrical shape as described above, the outward direction R may be a radial direction of the coupling member 140.

With continued reference to FIGS. 1-5, the one or more ball members 150 are provided to protrude in the outward direction R from the coupling member 140. When an external force is applied, the one or more ball members 150 may be movable in a direction, i.e., an inward direction opposite to the outward direction R.

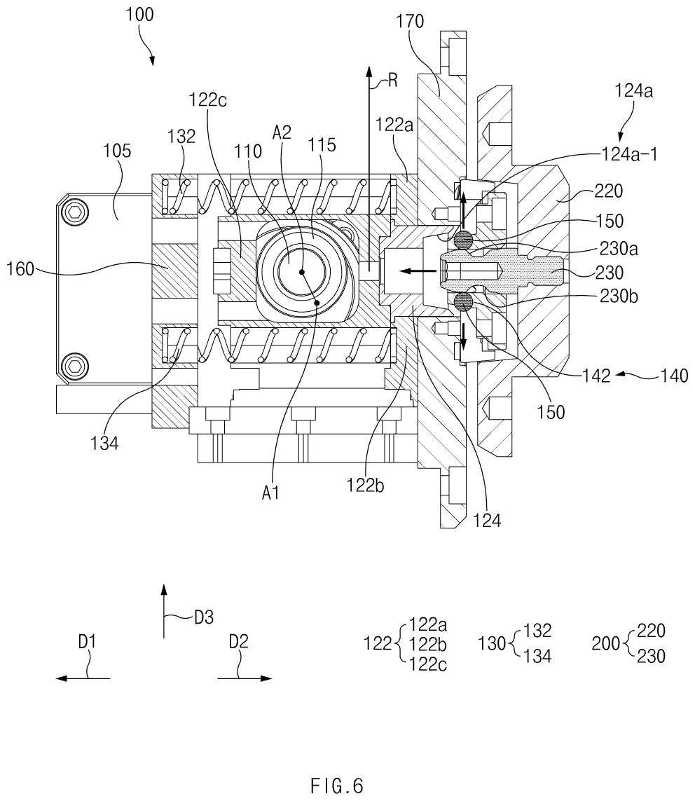

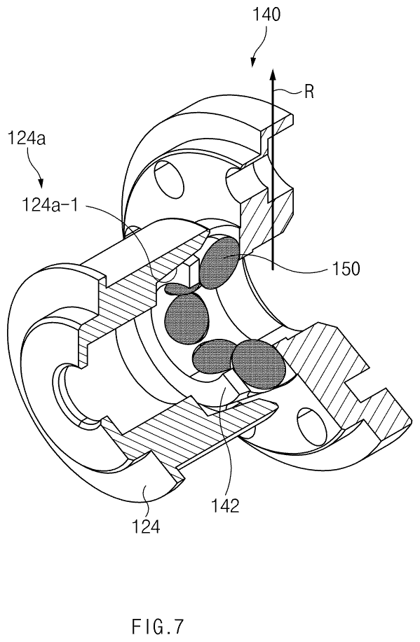

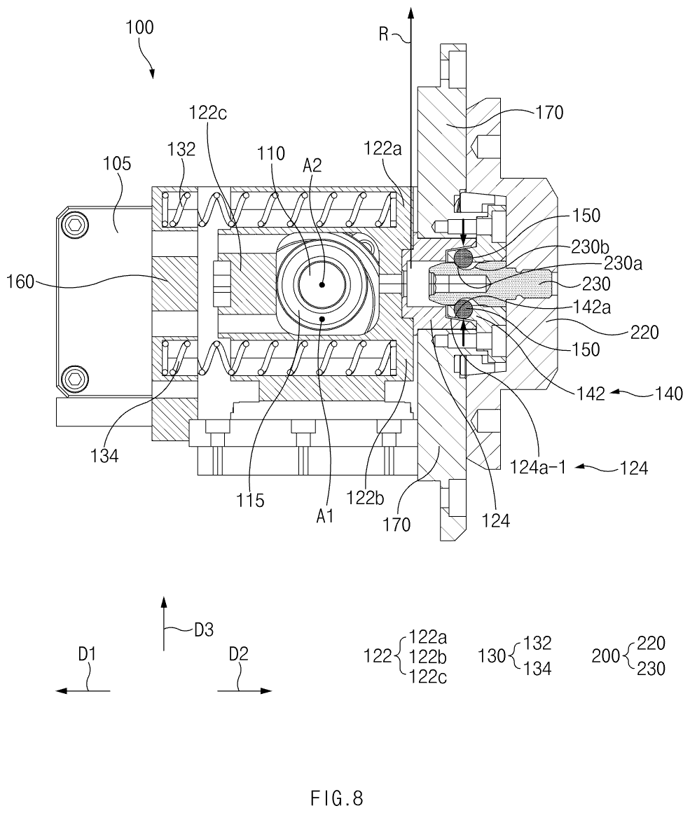

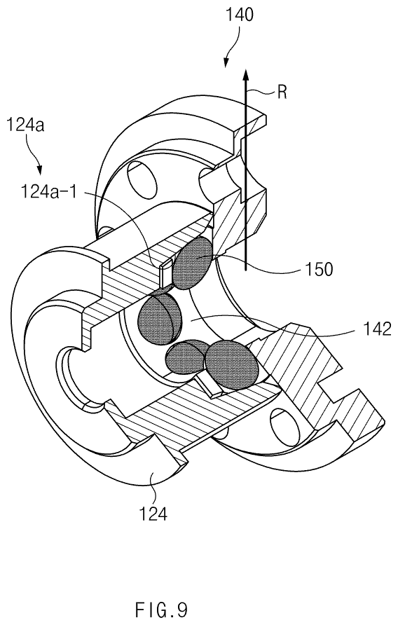

FIG. 6 is a cross-sectional view illustrating the attachment/detachment device and the charger in a first state of the charging module according to the embodiment of the present disclosure. FIG. 7 is a view illustrating a positional relationship between a cup member, the ball members, and the coupling member in FIG. 6. FIG. 8 is a cross-sectional view illustrating the attachment/detachment device and the charger in a second state of the charging module according to the embodiment of the present disclosure. FIG. 9 is a view illustrating a positional relationship between the cup member, the ball members, and the coupling member in FIG. 8.

According to the present disclosure, the state of the charging module 10, the attachment/detachment device 100, or the charger 200 may be broadly divided into a first state and a second state. The first state may mean a state in which the movable part 120 is moved in the first direction D1 by a predetermined distance as the pressing part 110 presses the movable part 120 by the operation of the driving part 105, as illustrated in FIGS. 6 and 7. In contrast, the second state may mean a state in which the movable part 120 is moved in the second direction D2 by a predetermined distance, as illustrated in FIGS. 8 and 9, in comparison with the first state. More specifically, the first state may be understood as a state in which the movable part 120 is moved in the first direction D1 by a predetermined distance when a pressing force applied to the movable part 120 by the pressing part 110 is higher than a pressing force applied to the movable part 120 by the elastic member 130. The second state may be understood as a state in which the movable part 120 is moved in the second direction D2, in comparison with the movable part 120 in the first state, when a pressing force applied to the movable part 120 by the elastic member 130 is higher than a pressing force applied to the movable part 120 by the pressing part 110. For example, in the second state, the driving part 105, e.g., the motor does not operate, and a rotation angle of the driving axis A1 of the driving part 105 may be 0 degrees. The second state may be a state in which the driving axis A1 is rotated by a predetermined rotation angle as the driving part 105 operates in the first state.

In this case, according to the present disclosure, as illustrated in FIGS. 6 and 7, in the first state, the ball members 150 may be positioned at predetermined positions in relation to the coupling member 140. As illustrated in FIGS. 8 and 9, in the second state, the movable part 120 may press the ball members 150 in the direction, i.e., the inward direction (hereinafter, referred to as an ‘inward direction’) opposite to the outward direction R, such that the ball members 150 may move toward the inside of the coupling member 140 in comparison with the positions of the ball members 150 in the first state. In this case, the configuration in which the movable part 120 presses the ball members 150 in the inward direction does not mean that a direction of a force applied to the ball members 150 by the movable part 120 is only parallel to the outward direction R or the inward direction. In other words, in the present specification, the movable part 120 may be considered as pressing the ball members 150 in the inward direction as long as there is a vector component of a force directed in the inward direction among the components of the force by which the movable part 120 presses the ball members 150.

According to the present disclosure, the first state may be one of the processes of physically uncoupling the attachment/detachment device 100 and the charger 200 that constitute the charging module 10 according to the present disclosure. In other words, in the first state, the movable part 120 moves in the first direction D1 and does not press the ball members 150, such that the ball members 150 may protrude from the coupling member 140 in the outward direction R. In this case, as described below, the ball members 150 are configured to mediate the physical engagement between the attachment/detachment device 100 and the charger 200. In case that the ball members 150 protrude in the outward direction R, the physical engagement between the attachment/detachment device 100 and the charger 200 may be released. Therefore, in the first state, the attachment/detachment device 100 and the charger 200 may move relative to each other in the first direction D1 and the second direction D2.

In contrast, the second state may be a state in which the attachment/detachment device 100 and the charger 200, which constitute the charging module 10 according to the present disclosure, are physically coupled. In other words, in comparison with the first state, the movable part 120 is in a state of being moved in the second direction D2 in the second state in comparison with the movable part 120 in the first state, such that the ball members 150 may be moved in the inward direction by the movable part 120. Therefore, the attachment/detachment device 100 and the charger 200 may be physically coupled by the ball members 150. Therefore, in the second state, the attachment/detachment device 100 and the charger 200 cannot move relative to each other in the first direction D1 and the second direction D2.

The movable part 120 may be divided into a plurality of regions. More specifically, with reference to the above-mentioned drawings, the movable part 120 may include a slider member 122 having an internal space for accommodating the elastic member 130, and a cup member 124 provided at one side of the slider member 122 based on the second direction D2 and fixedly coupled to the slider member 122. The slider member 122 may be configured to be directly pressed by the pressing part 110 or the elastic member 130, and the cup member 124 may be configured to selectively press the ball members 150 depending on a movement of the slider member 122. The slider member 122 may be integrally configured. Alternatively, the slider member 122 may include a plurality of components, and the plurality of components may be structured to be fixedly coupled to one another.

In order for the elastic member 130 to press the movable part 120 or the slider member 122 in the second direction D2 at ordinary times, one side of the elastic member 130 needs to be in contact with the movable part 120 or the slider member 122. Additionally, the other side of the elastic member 130 needs to be supported by another separate component other than the movable part 120 or the slider member 122.

Therefore, the attachment/detachment device 100 of the charging module 10 according to the present disclosure may further include a support member 160 having one side at which the slider member 122 and the elastic member 130 are provided. In this case, an end of the elastic member 130 based on the first direction D1 may be in contact with an inner surface of the support member 160, and an end of the elastic member 130 based on the second direction D2 may be in contact with an inner surface of the slider member 122 provided at one side based on the second direction D2 and configured to define the internal space of the slider member 122. In other words, according to the present disclosure, because the end of the elastic member 130 based on the first direction D1 is supported by the support member 160, the elastic member 130 may stably press the movable part 120 or the slider member 122 at ordinary times. The support member 160 may be integrally configured. Alternatively, the support member 160 may include a plurality of components, and the plurality of components may be structured to be fixedly coupled to one another.

With continued reference to the above-mentioned drawings, the coupling member 140 of the attachment/detachment device 100 may include a coupling region 142 in which a plurality of accommodation holes for accommodating the one or more ball members 150 is formed in a circumferential direction in an outer surface of the coupling region 142 based on the outward direction R. For example, the outer surface of the coupling region 142 based on the outward direction R may have a cylindrical shape. Additionally, the plurality of accommodation holes for accommodating the one or more ball members 150 may be formed in the outer surface at equal intervals in the circumferential direction of the cylindrical shape. More specifically, the plurality of accommodation holes may be provided at equal intervals in the circumferential direction of the outer surface of the coupling region 142 based on the outward direction R, and the ball members 150 may be respectively accommodated in the accommodation holes.

In addition, the attachment/detachment device 100 may further include a fixing member 170 fixed to a lateral portion of the support member 160 based on the second direction D2. For example, the fixing member 170 may have an approximate plate shape. In this case, the coupling member 140 may be fixedly coupled to a lateral portion of the fixing member 170 based on the second direction D2. In other words, the fixing member 170 may be configured to fix the coupling member 140 relative to the support member 160 regardless of the movement of the movable part 120 including the cup member 124.

In this case, according to the present disclosure, at least a partial region of the cup member 124 may also be inserted into the fixing member 170, and the cup member 124 may be provided to face the coupling member 140 through a region of the cup member 124 inserted into the fixing member 170. Therefore, as described below, one region of a connection pin member 230 of the charger 200 may penetrate the coupling member 140 and then be inserted into the cup member 124.

According to the present disclosure, the pressing part, the movable part, the elastic member, and the ball member of the attachment/detachment device 100 may have approximately symmetric shapes in a direction intersecting the first direction D1 and the second direction D2. More specifically, with reference to the above-mentioned drawings, the elastic members 130 may include a first elastic member 132 and a second elastic member 134 provided to be spaced apart from each other in a third direction D3 that is a direction intersecting the first direction D1 and the second direction D2. More specifically, the third direction D3 may be a direction perpendicularly intersecting the first direction D1 and the second direction D2. For example, the third direction D3 may be an upward/downward direction or a horizontal direction. For reference, in the drawings in the present specification, the third direction D3 is illustrated as the upward/downward direction.

The internal space formed in the slider member 122 may include a first internal space for accommodating the first elastic member 132, and a second internal space for accommodating the second elastic member 134. The slider member 122 may include a first slider region 122a having the first internal space, a second slider region 122b having the second internal space, and a connection region 122c provided to connect the first slider region 122a and the second slider region 122b. The slider member 122 may have an approximate ‘U’ shape.

In addition, according to the present disclosure, the pressing part 110 may be provided between the first elastic member 132 and the second elastic member 134 in the third direction D3, and the connection region 122c may be provided at a side of the pressing part 110 based on the first direction D1. Therefore, in case that the pressing part 110 revolves around the driving axis A1, the pressing part 110 may press the connection region 122c in the first direction D1.

According to the present disclosure, the cup member 124 of the movable part 120 may have a recessed region 124a having a shape opened to the outside in the second direction D2 and having a shape recessed in the first direction D1. The recessed region 124a may provide a space into which some components of the charger 200 are inserted when the attachment/detachment device 100 and the charger 200 are physically coupled to each other. More specifically, the recessed region 124a may define a space into which a part of the connection pin member 230 to be described below is inserted.

In this case, as illustrated in the drawings, an inner surface of the recessed region 124a based on the inward direction may include a first-first inclined section 124a-1 having a shape with a width based on the outward direction R that decreases in the first direction D1. The first-first inclined section 124a-1 may be a section that comes into direct contact with the ball members 150 when the cup member 124 of the movable part 120 presses the ball members 150 in the inward direction R in the second state of the charging module 10. In other words, according to the present disclosure, in the second state, the ball members 150 may be pressed by the first-first inclined section 124a-1 of the recessed region 124a. In contrast, the ball members 150 may be spaced apart from the first-first inclined section 124a-1 in the second direction D2 in the first state, i.e., the state in which the pressing part 110 moves the cup member 124 of the movable part 120 by a predetermined distance in the first direction D1 by the operation of the driving part 105 in comparison with the cup member 124 in the second state. For example, as illustrated in FIGS. 6 and 8 and the like, the first-first inclined section 124a-1 may be formed in an end region based on the second direction D2 of the recessed region 124a of the cup member 124.

The coupling region 142 of the coupling member 140 may have a section having a shape corresponding to the first-first inclined section 124a-1. More specifically, with reference to FIGS. 6 and 8, the outer surface of the coupling region 142 based on the outward direction R may further include a first-second inclined section 142a having a width based on the outward direction R that decreases in the first direction D1. In this case, the first-first inclined section 124a-1 may be provided outward of the first-second inclined section 142a in the inward direction, and the accommodation holes for accommodating the ball members 150 may be formed in the first-second inclined section 142a.

The first-second inclined section 142a may be understood as a section that comes into contact with the first-first inclined section 124a-1 when the first-first inclined section 124a-1 presses the ball members 150 and moves the ball members 150 in the inward direction in the second state. Therefore, according to the present disclosure, a gradient of the first-first inclined section 124a-1 with respect to the first direction D1 and the second direction D2 and a gradient of the first-second inclined section 142a with respect to the first direction D1 and the second direction D2 may correspond to each other. More particularly, the two gradients may be identical to each other.

The attachment/detachment device 100 may further include a sensor member 180 configured to detect the component that approaches the attachment/detachment device 100. The sensor member 180 may be fixed to and provided on the lateral portion of the fixing member 170 based on the second direction D2. The sensor member 180 may be configured to detect whether the charger 200, which approaches the attachment/detachment device 100, is tightly attached to the attachment/detachment device 100 so as to be coupled to the attachment/detachment device 100. In addition, the attachment/detachment device 100 may further include a camera configured to identify and measure a position of the charger 200 that approaches the attachment/detachment device 100.

Hereinafter, the charger 200 provided in the charging module 10 according to the present disclosure is described in detail.

The charging module 10 according to the present disclosure may further include the charger 200 detachably provided on the attachment/detachment device 100. Hereinafter, the components of the charger 200 are described based on a case in which the charger 200 is positioned when the charger 200 is coupled to the attachment/detachment device 100 or a state in which the charger 200 may be coupled to the attachment/detachment device 100.

The charger 200 may include a charger body 210 configured to define a body of the charger 200, and a bracket member 220 provided at one side of the charger body 210 and provided to face the coupling member 140 of the attachment/detachment device 100. The bracket member 220 may be fixedly coupled to a lateral portion of the charger body 210 based on the first direction D1 during the processes of coupling and uncoupling the attachment/detachment device 100 and the charger 200. As illustrated in FIG. 8, the bracket member 220 may be tightly attached to the fixing member 170 in the second state in which the attachment/detachment device 100 and the charger 200 are coupled to each other.

The charger 200 may further include the connection pin member 230 protruding from the bracket member 220 toward the coupling member 140 and configured to be inserted into the coupling member 140 based on the state in which the charger 200 may be coupled to the attachment/detachment device 100 or the state in which the charger 200 is coupled to the attachment/detachment device 100. The connection pin member 230 may be configured to mediate the engagement between the attachment/detachment device 100 and the charger 200. In other words, according to the present disclosure, the connection pin member 230 is fixedly coupled to one side of the attachment/detachment device 100, such that the attachment/detachment device 100 and the charger 200 may be coupled to each other. When the connection pin member 230 is uncoupled from one side of the attachment/detachment device 100, the attachment/detachment device 100 and the charger 200 may be uncoupled.

More specifically, according to the present disclosure, the ball members 150 may be positioned at a predetermined position in relation to the coupling member 140 in the first state in which the movable part 120 is moved in the first direction D1 by a predetermined distance as the pressing part 110 presses the movable part 120 by the operation of the driving part 105. The first state may be a state in which the movable part 120 does not substantially press the ball members 150 in the inward direction. In this case, the configuration in which the movable part does not substantially press the ball members may be interpreted as including not only a case in which the movable part 120 is physically spaced apart from the ball members 150, but also a case in which one side (e.g., the cup member) of the movable part 120 is in physical contact with the ball members 150 to a degree to which the movements of the ball members 150 are not caused.

In this case, the ball members 150 may protrude from the outer surface of the coupling region 142 based on the outward direction R. In contrast, in the second state that is a state in which the movable part 120 is moved in the second direction D2 by a predetermined distance in comparison with the first state, the cup member 124 of the movable part 120 may press the ball members 150 in the inward direction by the first-first inclined section 124a-1, such that the ball members 150 may move toward the inside of the coupling member 140 in the inward direction in comparison with the positions of the ball members 150 in the first state. Therefore, the ball members 150, which are moved in the inward direction in the second state, may press an outer surface based on the outward direction R of the connection pin member 230 inserted into one side (i.e., the recessed region 124a) of the movable part 120. Therefore, in the second state, the attachment/detachment device 100 and the charger 200 may be fixedly coupled to each other by interference between the ball members 150 and the connection pin member 230. In contrast, in the first state, the movable part 120 presses the ball members 150 in the inward direction to release them, such that the interference between the ball members 150 and the connection pin member 230 may be eliminated, and the attachment/detachment device 100 and the charger 200 may move relative to each other. The ball members 150 may be provided between the connection pin member 230 and the region (i.e., the first-first inclined section) based on the outward direction R of the movable part 120, which presses the ball members 150, in the first state and the second state so that the interference between the ball members 150 and the connection pin member 230 occurs in the second state.

The outer surface of the connection pin member 230 based on the outward direction R may be divided into a plurality of sections depending on the shape thereof.

More specifically, with reference to FIGS. 6 and 8 and the like, the outer surface of the connection pin member 230 based on the outward direction R may include a second-first inclined section 230a having a width based on the outward direction R that increases in the first direction D1. The second-first inclined section 230a may be a section that the ball members 150 directly press in the second state. The second-first inclined section 230a may be a section that generates the interference between the ball members 150 and the connection pin member 230 that is required to couple the attachment/detachment device 100 and the charger 200. Therefore, according to the present disclosure, the second-first inclined section 230a and the ball members 150 may be provided to overlap one another in the first direction D1 and the second direction D2 when the connection pin member 230 is inserted into the coupling member 140 in the first state, such that the ball members 150 may press the second-first inclined section 230a in the second state. In this case, in the second state, the ball members 150 may press the second-first inclined section 230a while moving in the inward direction R.

The outer surface of the connection pin member 230 based on the outward direction R may further include another inclined section in addition to the second-first inclined section 230a. In other words, with reference to FIGS. 6 and 8, the outer surface of the connection pin member 230 based on the outward direction R may further include a second-second inclined section 230b connected to an end of the second-first inclined section 230a based on the second direction D2 and having a width based on the outward direction R that decreases in the first direction D1. In this case, a cross-section, which is made by cutting the outer surface of the connection pin member 230 in the first direction D1 or the second direction D2 may be understood as including an approximate ‘U’ or ‘V’ shape.

With reference to FIGS. 1-3, the attachment/detachment device 100 according to the present disclosure may further include a push member 190 configured to be rotatable about a rotation axis defined at one side. The charger 200 may further include a lever button 250 configured to be pressed by the push member 190 when the push member 190 rotates by a predetermined rotation angle in the state in which the attachment/detachment device 100 and the charger 200 are coupled to each other. In addition, the charger 200 may further include a lever member 240 configured to be rotatable in conjunction with the lever button 250 when the lever button 250 is pressed. In addition, the charging module 10 according to the present disclosure may further include a cradle 300 including a mounting part 310 configured to define a region in which the charger 200 may be mounted. Additionally, the charging module 10 may include a latch part 320 provided at one side of the mounting part 310 and configured to be coupled to the lever member 240. For example, the lever member 240 may include a hook structure with a bent longitudinal end. The latch part 320 may include a structure into which the hook structure may be inserted. Therefore, the charger 200 and the cradle 300 may be coupled when the hook structure of the lever member 240 is inserted into the latch part 320 when the charger 200 is seated on the mounting part 310. On the contrary, when the lever member 240 rotates as the lever button 250 is pushed, the hook structure of the lever member 240 is moved away from the latch part 320, such that a state in which the charger 200 and the cradle 300 may be uncoupled may be made.

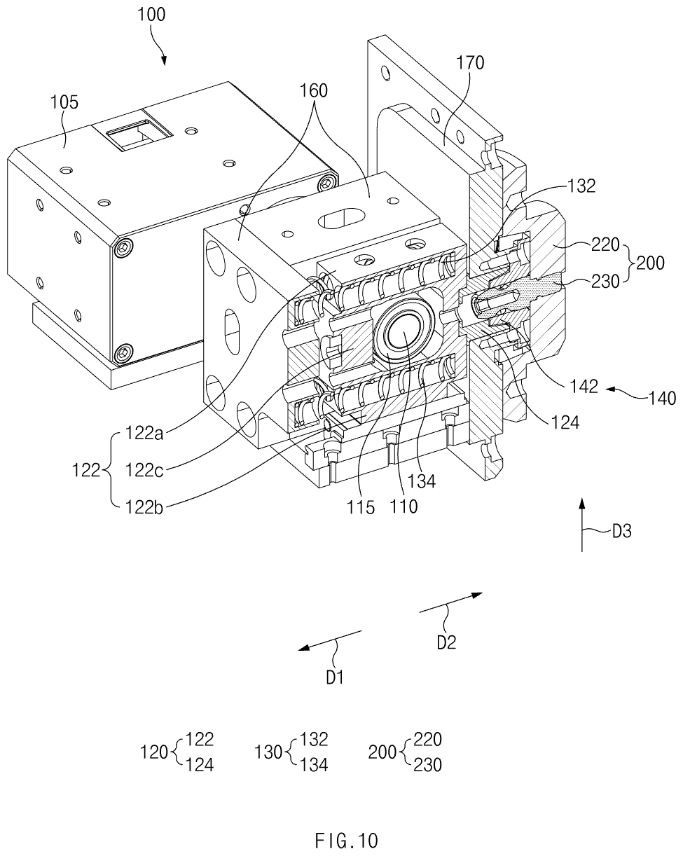

FIG. 10 is a view illustrating internal cross-sectional structures of some components of a charger and an attachment/detachment device of a charging module according to another embodiment of the present disclosure.

The charging module 10 according to another embodiment of the present disclosure differs from the charging module according to the above-mentioned embodiment of the present disclosure in that the attachment/detachment device and the charger are not coupled by pressing the ball members against the connection pin member.

More specifically, with reference to FIG. 10, the charging module 10 according to the present disclosure may include the attachment/detachment device 100, and the charger 200 detachably provided on the attachment/detachment device 100.

The attachment/detachment device 100 may include the driving part 105 having the driving axis A1 and configured to rotate about the driving axis A1. The attachment/detachment device 100 may further include: the pressing part 110 configured to rotate in conjunction with the rotation of the driving axis A1; the movable part 120 provided at one side of the pressing part 110 and configured to be movable in the first direction D1 by the rotation of the pressing part 110; and the elastic member 130 provided at one side of the movable part 120 and configured to press the movable part 120 in the second direction D2 that is the direction opposite to the first direction D1. Additionally, the attachment/detachment device 100 may include the coupling member 140 provided to face one side of the movable part 120 based on the second direction D2. In addition, the charger 200 may include the bracket member 220 provided to face the coupling member 140 of the attachment/detachment device 100, and the connection pin member 230 protruding from the bracket member 220 toward the coupling member 140 and configured to be inserted into the coupling member 140.

In this case, according to another embodiment of the present disclosure, the connection pin member 230 and an end of the movable part 120 based on the second direction D2 may be attached to or detached from each other by a magnetic force. For example, the end of the movable part 120 based on the second direction D2, i.e., the cup member 124 may include an electromagnet, and the connection pin member 230 may include a permanent magnet. Alternatively, as another example, the cup member 124 may include a permanent magnet, and the connection pin member 230 may include an electromagnet.

The above-mentioned description of the contents in the embodiment of the present disclosure may also be equally applied to the description of another embodiment of the present disclosure unless the contents are contradictory to the description of another embodiment of the present disclosure.

### Method of Operating Charging Module

Hereinafter, a method of operating the charging module 10 according to the present disclosure is described with reference to the above-mentioned description.

The method of operating the charging module 10 according to the present disclosure may include: step i) of allowing the attachment/detachment device 100 to approach the charger 200 in the state in which the charger 200 is coupled to the cradle 300; step ii) of coupling the attachment/detachment device 100 and the charger 200 by inserting the connection pin member 230 of the charger 200 into the recessed region 124a formed in the cup member 124 of the attachment/detachment device 100; and step iii) of rotating the push member 190 of the attachment/detachment device 100 to allow the push member 190 to press the lever button 250 and rotating the lever member 240 to move the lever member 240 away from the latch part 320. The method may also include: step iv) of moving the charger 200 away from the cradle 300 in the state in which the attachment/detachment device 100 and the charger 200 are coupled to each other; step v) of inserting the charger 200 into a demander, such as an electric vehicle, required to be charged; and step vi) of moving the attachment/detachment device 100 away from the charger 200 in the state in which the charger 200 is inserted into the demander.

More specifically, in step ii), the attachment/detachment device 100 may be in the second state. Therefore, the movable part 120 may be pressed in the second direction D2 by the elastic member 130, and the cup member 124 of the movable part 120 may be tightly attached to a lateral surface of the fixing member 170 based on the first direction D1. In other words, the second state may be a state in which the cup member 124 is maximally moved in the second direction D2. Therefore, the ball members 150 may be pressed in the inward direction R by the cup member 124, such that the ball members 150 may press the connection pin member 230 inserted into the recessed region 124a. Therefore, in step ii), the attachment/detachment device 100 and the charger 200 may be coupled. For example, the second state may be a state in which the driving part 105, more particularly, the motor does not operate.

In step vi), the attachment/detachment device 100 may be in the first state. Therefore, even though the movable part 120 is pressed in the second direction D2 by the elastic member 130 at ordinary times, the pressing part 110 presses the slider member 122 of the movable part 120 in the first direction D1 and moves the slider member 122 in the first direction D1 by the operation of the driving part 105, such that the cup member 124 also moves in the first direction D1. Therefore, the state in which the cup member 124 presses the ball members 150 in the inward direction is eliminated. Thereafter, when the charger 200 moves away from the attachment/detachment device 100, the connection pin member 230 may move without interfering with the ball members 150, such that the attachment/detachment device 100 and the charger 200 may be uncoupled.

According to the present disclosure, the attachment/detachment device 100 and the charger 200 may be coupled or uncoupled by the automated process instead of an effort of the operator. Thus, it is possible to automate the process of providing electric power, through the charger, to the demander, such as the electric vehicle, required to be charged.

The present disclosure has been described with reference to the limited embodiments and the drawings, but the present disclosure is not limited thereby. The present disclosure may be carried out in various forms by those having ordinary skill in the art, to which the present disclosure pertains, within the technical spirit of the present disclosure and the scope equivalent to the appended claims.

What is claimed is:

1. An attachment/detachment device comprising:
a driving part including a driving axis and configured to rotate about the driving axis;
a pressing part configured to rotate in conjunction with the rotation of the driving axis;
a movable part provided at one side of the pressing part and configured to be movable in a first direction by the rotation of the pressing part;
an elastic member provided at one side of the movable part and configured to press the movable part in a second direction;
a coupling member provided to face one side of the movable part based on the second direction; and
one or more ball members accommodated in the coupling member,
wherein the one or more ball members are provided to protrude outward from the coupling member,
wherein the one or more ball members are positioned at a predetermined position in relation to the coupling member in a first state in which the movable part is moved in the first direction as the pressing part presses the movable part by an operation of the driving part, and
wherein the movable part presses the one or more ball members in an inward direction, which is a direction opposite to an outward direction, and the one or more ball members move toward an inside of the coupling member from a position of the one or more ball members in the first state to a position of the one or more ball members in a second state in which the movable part is moved in the second direction by a predetermined distance in comparison with the first state.

2. The attachment/detachment device of claim 1, wherein the pressing part is configured to revolve around the driving axis of the driving part.

3. The attachment/detachment device of claim 1, wherein the movable part comprises:
a slider member having an internal space for accommodating the elastic member; and
a cup member provided at one side of the slider member based on the second direction and fixedly coupled to the slider member.

4. The attachment/detachment device of claim 3, further comprising:
a support member having one side at which the slider member and the elastic member are provided,
wherein an end of the elastic member based on the first direction is in contact with an inner surface of the support member, and
wherein an end of the elastic member based on the second direction is in contact with an inner surface of the slider member provided at one side based on the second direction and configured to define the internal space of the slider member.

5. The attachment/detachment device of claim 3, wherein the coupling member comprises a coupling region in which a plurality of accommodation holes for accommodating the one or more ball members is formed in a circumferential direction in an outer surface of the coupling region based on the outward direction.

6. The attachment/detachment device of claim 4, further comprising:
a fixing member fixed to a lateral portion of the support member based on the second direction,
wherein the coupling member is fixedly coupled to a lateral portion of the fixing member based on the second direction, and
wherein the cup member is inserted into the fixing member and provided to face the coupling member.

7. The attachment/detachment device of claim 1, wherein the elastic member comprises first and second elastic members spaced apart from each other in a third direction intersecting the first direction.

8. The attachment/detachment device of claim 7, wherein the pressing part is provided between the first and second elastic members in the third direction.

9. The attachment/detachment device of claim 5, wherein the cup member has a recessed region having a shape opened in the second direction and having a shape recessed in the first direction, and
wherein an inner surface of the recessed region based on the inward direction includes a first-first inclined section having a width based on an outward direction that decreases in the first direction.

10. The attachment/detachment device of claim 9, wherein an outer surface of the coupling region based on the outward direction includes a first-second inclined section having a width based on the outward direction that decreases in the first direction, and
wherein the first-first inclined section is provided outward of the first-second inclined section in the outward direction.

11. The attachment/detachment device of claim 10, wherein a gradient of the first-first inclined section with respect to the first direction and a gradient of the first-second inclined section with respect to the first direction correspond to each other.

12. The attachment/detachment device of claim 9, wherein the one or more ball members are spaced apart from the first-first inclined section in the first state, and wherein the one or more ball members are pressed by the first-first inclined section in the second state.

13. A charging module comprising:
the attachment/detachment device according to claim 1; and
a charger detachably provided on the attachment/detachment device,
wherein the charger includes:
a bracket member provided to face the coupling member of the attachment/detachment device; and
a connection pin member protruding from the bracket member toward the coupling member and configured to be inserted into the coupling member, and
wherein the one or more ball members press an outer surface based on the outward direction of the connection pin member inserted into one side of the movable part in the second state.

14. The charging module of claim 13, wherein in the second state, the one or more ball members are provided between the connection pin member and a region based on the outward direction of the movable part that presses the one or more ball members.

15. The charging module of claim 14, wherein the movable part comprises:
a slider member having an internal space for accommodating the elastic member; and
a cup member provided at one side of the slider member based on the second direction and fixedly coupled to the slider member, and
wherein the coupling member includes a coupling region having an outer surface with a cylindrical shape and having a plurality of accommodation holes configured to accommodate the one or more ball members and formed in the outer surface in a circumferential direction of the cylindrical shape.

16. The charging module of claim 15, wherein the cup member has a recessed region having a shape opened in the second direction and having a shape recessed in the first direction,
wherein an inner surface of the recessed region includes a first-first inclined section having a width based on the outward direction that decreases in the first direction,
wherein an outer surface of the coupling region includes a first-second inclined section having a width based on the outward direction that decreases in the first direction, and
wherein the first-first inclined section is provided outward of the first-second inclined section in the outward direction.

17. The charging module of claim 16, wherein an outer surface of the connection pin member based on the outward direction includes a second-first inclined section having a width based on the outward direction that increases in the first direction, and
wherein the second-first inclined section and the one or more ball members are provided to overlap each other in the first direction when the connection pin member is inserted into the coupling member in the first state.

18. The charging module of claim 17, wherein the outer surface of the connection pin member based on the outward direction further includes a second-second inclined section connected to an end of the second-first inclined section based on the second direction and having a width based on the outward direction that decreases in the first direction.

19. A charging module comprising:
an attachment/detachment device; and
a charger detachably provided on the attachment/detachment device,
wherein the attachment/detachment device includes:
a driving part having a driving axis and configured to rotate about the driving axis;
a pressing part configured to rotate in conjunction with the rotation of the driving axis;
a movable part provided at one side of the pressing part and configured to be movable in a first direction by the rotation of the pressing part;
an elastic member provided at one side of the movable part and configured to press the movable part in a second direction D2 that is a direction opposite to the first direction; and
a coupling member provided to face one side of the movable part based on the second direction,
wherein the charger includes:
a bracket member provided to face the coupling member of the attachment/detachment device; and
a connection pin member protruding from the bracket member toward the coupling member and configured to be inserted into the coupling member, and
wherein an end of the movable part based on the second direction and the connection pin member are attachable to or detachable from each other by a magnetic force.

20. The charging module of claim 19, wherein the end of the movable part based on the second direction includes an electromagnet, and the connection pin member includes a permanent magnet.
